(19) United States
(12) Patent Application Publication
(10) Pub. No.: US 2015/0341064 A1
(43) Pub. Date: Nov. 26, 2015

(54) A RECEIVER CIRCUIT

(71) Applicant: THE UNIVERSITY OF MELBOURNE, Victoria (AU)

(72) Inventors: Robin J Evans, Melbourne, Victoria (AU); Efstratios Skafidas, Melbourne, Victoria (AU); Hoa Thai Duong, Melbourne, Victoria (AU); Viet Hoang Le, Melbourne, Victoria (AU); John Li, Melbourne, Victoria (AU)

(21) Appl. No.: 14/654,379

(22) PCT Filed: Dec. 18, 2013
(86) PCT No.: PCT/AU2013/001483

§ 371 Date: Jun. 19, 2015

(30) Foreign Application Priority Data
Dec. 20, 2012 (AU) 2012905586

(51) Int. Cl. H04B 1/16

(52) U.S. Cl. CPC H04B 1/16

(57) ABSTRACT

A receiver circuit comprising first and second antennas; an input amplification stage comprising first and second input amplifier circuits for amplifying first and second signals received at the first and second antennas respectively; a switching stage comprising first and second transconductance components connected respectively to the first and second input amplifier circuits and to a common output, and a switching mechanism arranged to selectively turn on and off the first and second transconductance components so that only one of the first and second transconductance components is in an on state at any time, the first and second transconductance components further amplifying the first and second signals respectively when in an on state; and an output amplification stage connected to the common output of the switching stage and comprising an output amplifier circuit for further amplifying the first and second signals when they are outputted via the common output.

### FIELD

The present invention relates to a receiver circuit and an amplifying and switching circuit for a radar receiver.

### BACKGROUND

Automotive radar systems may be installed in vehicles to assist drivers. These systems may provide the driver with information about distance between the driver's vehicle and other vehicles or obstacles present on the road. In some implementations, radar systems can be used to control aspects of operation of the vehicle, for example to control the braking system to avoid a crash.

In automotive radar systems, the transmitter sends out a signal through a transmit antenna. The propagated signal reaches the target and partially reflects back to the radar system. The reflected signal is picked up by a receive antenna of a receiver circuit (Rx). In order to assist with high resolution detection, the receiver can have a plurality of antennas, each with its own receive channel as shown in FIG. 1. A drawback of this architecture is that it requires a complex local oscillation (LO) distribution network to provide LO signals for mixers in the Rx circuits that are used to recover information from the reflected signal.

It would be advantageous to provide an alternative receiver circuit.

### SUMMARY OF THE INVENTION

In a first aspect, the invention provides a receiver circuit comprising:

a first antenna;

a second antenna;

an input amplification stage comprising a first input amplifier circuit for amplifying a first signal received at the first antenna, and second input amplifier circuit for amplifying a second signal received at the second antenna;

a switching stage comprising first and second transconductance components connected respectively to the first and second input amplifier circuits and to a common output, and a switching mechanism arranged to selectively turn on and off the first and second transconductance components so that only one of the first and second transconductance components is in an on state at any time, the first and second transconductance components further amplifying the first and second signals respectively when in an on state; and

an output amplification stage connected to the common output of the switching stage and comprising an output amplifier circuit for further amplifying the first and second signals when they are outputted via the common output.

In an embodiment, the first and second transconductance components comprise first and second transistors arranged in a common source topology.

In an embodiment, the common output is formed by connecting the drains of the first and second transistors.

In an embodiment, the receiver circuit comprises a third antenna and wherein the input amplification stage a third input amplifier circuit for amplifying a third signal received at the third antenna, and wherein the switching stage comprises a third transconductance component connected to the third input amplifier circuit and the common output for further amplifying the third signal, and wherein the switching mechanism is further arranged to turn the third transconductance component on and off.

In an embodiment, the third transconductance component comprise a third transistor arranged in a common source topology.

In an embodiment, the switching mechanism comprises fourth and fifth transistors connected respectively to the first and second transistors and which when switched on respectively turn on the first and second transistors.

In an embodiment, the switching mechanism comprises fourth, fifth and sixth transistors connected respectively to the first, second and third transistors and which when switched on respectively turn on the first, second and third transistors.

In an embodiment, the first and second input amplifier circuits each comprise a plurality of common source amplifiers.

In an embodiment, the first and second input amplifiers each comprise at least one input matching component.

In an embodiment, the first and second input amplifier circuits each comprise three common source amplifiers.

In an embodiment, the output amplifier circuit comprises a plurality of common source amplifiers.

In an embodiment, the receiver circuit comprises two common source amplifiers.

In a second aspect, the invention provides an amplifying and switching circuit for a radar receiver, the circuit comprising:

an input amplification stage comprising a first input for connection to a first antenna, a second input for connection to a second antenna, a first input amplifier circuit for amplifying a first signal received at the first input, and second input amplifier circuit for amplifying a second signal received at the second input;

a switching stage comprising first and second transconductance components connected respectively to the first and second input amplifier circuits and to a common output, and a switching mechanism arranged to selectively turn on and off the first and second transistors so that only one of the first and second transconductance components is in an on state at any time, the first and second transconductance components further amplifying the first and second signals respectively when in an on state; and

an output amplification stage connected to the common output of the switching stage and comprising an output amplifier circuit for further amplifying the first and second signals when they are outputted via the common output.

### BRIEF DESCRIPTION OF THE DRAWINGS

Embodiments of the invention will now be described in relation to the following drawings, in which:

FIG. 1 is a schematic diagram of a prior art receiver circuit;

FIG. 2 is a schematic diagram of a receiver circuit of an embodiment of the invention;

FIGS. 3a and 3b are schematic diagrams illustrating the operation of the receiver of FIG. 2;

FIG. 4 shows the operation of the switching stage of the receiver circuit of an embodiment;

FIG. 5 shows how the switching stage can be extended to allow the receiver circuit to accommodate more antennas;

FIG. 6 is a circuit diagram of an amplifying and switching circuit of an embodiment;

FIGS. 7a and 7b illustrate common source and Cascode amplifiers respectively;

FIG. 8 shows the simulated S parameter of the selected channel of the receiver circuit; and

FIG. 9 shows the simulated S parameter of the blocked channel of the receiver circuit.

### DETAILED DESCRIPTION

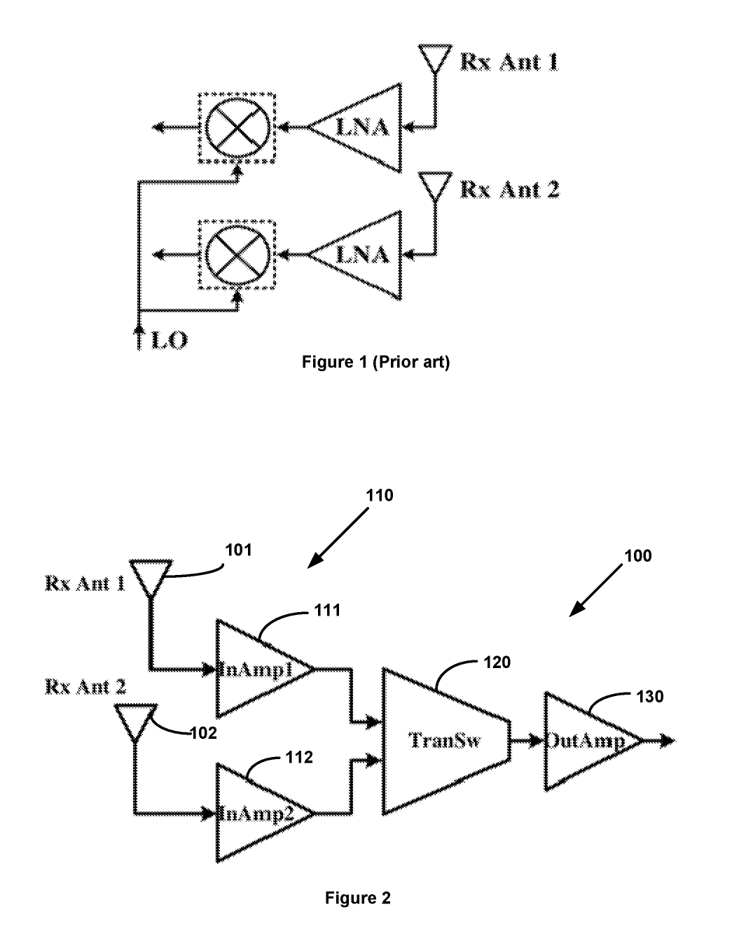

Referring to FIGS. 2 to 7, a receiver circuit 100 of an embodiment comprises two or more antennas with a switching stage that enables switching between the antennas so as to reduce the number of components required to form receiver channels while advantageously balancing power consumption, silicon area and reductions in Rx sensitivity. The proposed receiver circuit allows selection between two or more antennas and incorporates a switching stage that has conversion gain. The receiver circuit 100 reduces the number of local oscillation signals that need to be distributed to Rx mixers.

The receiver circuit 100 is intended to be implemented on a CMOS chip with a 65 nm process accordingly it will be appreciated that other components (such as a mixer) will be implemented on the same chip and form part of the radar receiver circuit.

A simplified diagram of a receiver circuit 100 for two antennas is shown in FIG. 2. The receiver circuit 100 has two antennas 101,102, an input amplication stage 110 comprising two input amplifier circuits 111,112 (InAmp1 and InAmp2), a switching stage 120 that implements a transconductance with switching function (TranSw), and an output amplifier stage 130 (OutAmp) which is then connected to further components of the receiver channel such as a mixer (not shown). It will be appreciated that signals received at the antennas 101,102 are amplified by the input stage 110 but only one of the signals is amplified by the output amplifier 130 at any time.

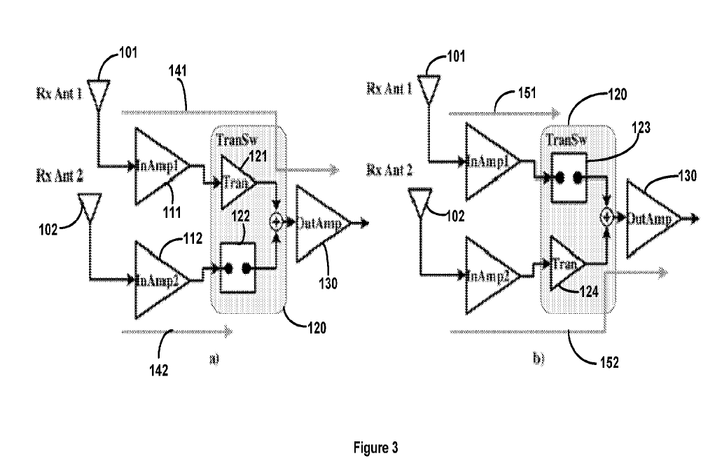

The operation of the proposed receiver circuit 100 is shown in FIG. 3. In FIG. 3a, when the input signal from RxAnt1 is selected, as indicated by arrow 141 a first transconductance component 121 of the TranSw 120 amplifies the signal received via InAmp1 101 from RxAnt1 which is then further amplified by OutAmp 130. As indicated by arrow 142, TranSW 120 blocks 122 the signal from RxAnt2 102. In FIG. 3b, when the input signal from RxAnt2 102 is selected, as indicated by arrow 152, a second transconductance component 124 of the TranSw 120 amplifies the signal from RxAnt2 102. As indicated by arrow 151, TranSW 120 blocks 123 the signal from RxAnt1 101.

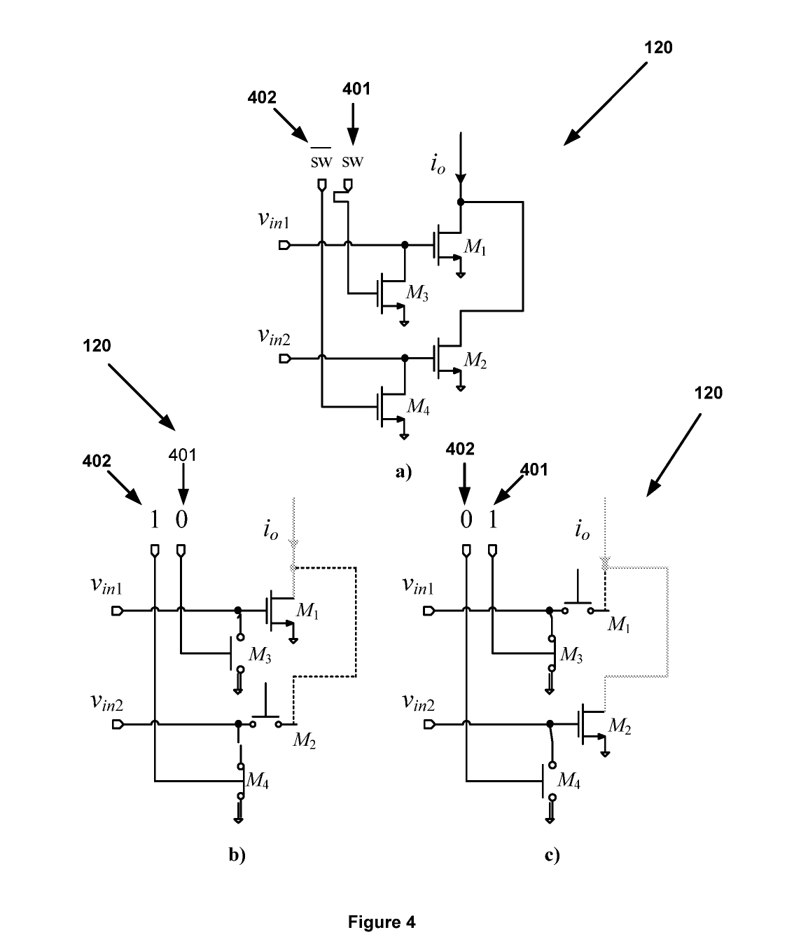

A schematic diagram of the switching stage 120 (TranSw) is shown in FIG. 4a. The TranSw 120 has a pair of common source amplifiers M₁ and M₂ whose drains are connected to provide a common output. Transistors M₃ and M₄ act as switching mechanism under control of switching signals 401, 402 which are the complement of one another and can be provided by a clock signal.

The operation of the TranSw 120 is described in relation to FIGS. 4b and c. When the received signal from channel 1 (vᵢₙ₁) is wanted (in this embodiment, the signal from InAmp1 111), in FIG. 4b, switching signal 401 is set so that M₃ is open, M₁ is biased as a normal common source amplifier, while switching signal 402 causes M₄ to short the signal from channel 2 (vᵢₙ₂) to ground as well as making M₂ off. As a result, the output current is only caused by vᵢₙ₁ and expressed by:

iₒ=vᵢₙ₁gₘ₁ (1)

In another words, the signal from channel 1 is let through while signal from channel 2 is blocked. When the receive signal from channel 2 (vᵢₙ₂) is wanted, in FIG. 4c, switching signal 401 is set so M₃ is shorts the signal from channel 1 (vᵢₙ₁) to ground as well as making M₁ off, while switching signal 402 is set so that M₄ is open and M₂ is biased as a normal common source amplifier. As a result, the output current is only caused by vᵢₙ₂ and expressed by:

iₒ=vᵢₙ₂gₘ₂ (2)

That is, the signal from channel 2 is let though while signal from channel 1 is blocked.

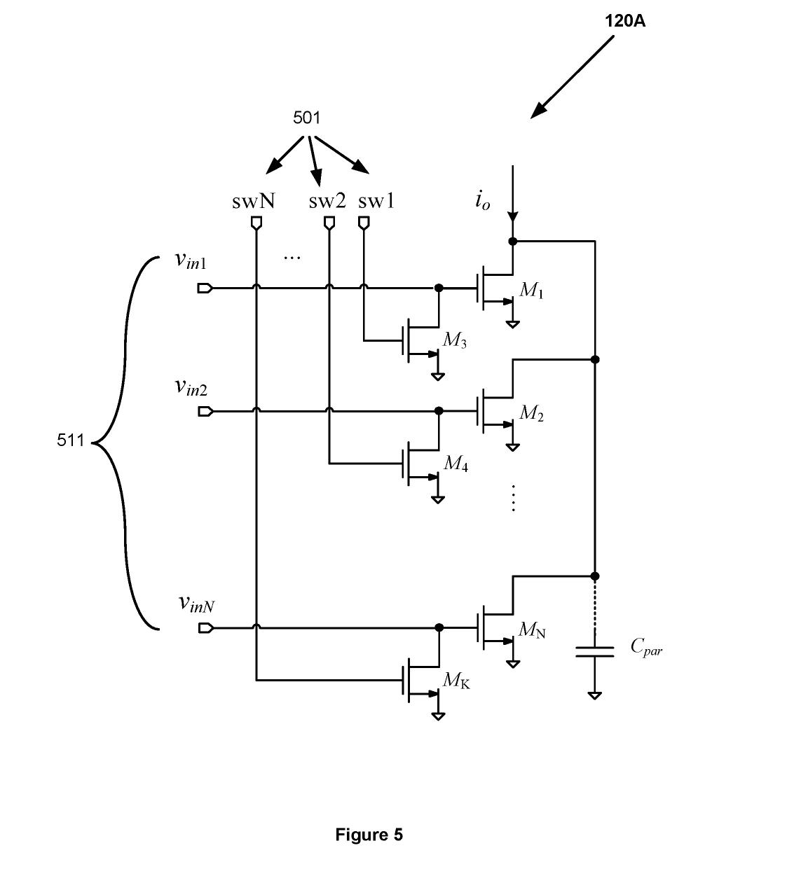

FIG. 5 shows how, the receiver circuit can be adapted to select an arbitrary number (N) of channels 511—i.e., with more than two antennas, for example with three antennas (when N=3). Note that the switching signals 501 for N channels that control switching transistors M₃, M₄ . . . M_{K} ensure only one of the amplifiers M₁,M₂ . . . M_{N} acts as a common source amplifier at any time while the other signals are blocked. However, it should be noted that the parasitic capacitance (Cₚₐᵣ) seen at the common drain is increased as the number of transistors increases. As a result, the gain of TranSw 120A of FIG. 5 will be decreased. Provided the gain and noise factor of each channel is within the specified requirements of the design, the number of channels can be increased.

In one embodiment, the receiver circuit 100 is designed for operation at 77 GHz. The receiver circuit 100 should provide input matching with both receive antennas at all times (irrespective of whether the channel is selected or blocked). The two inputs to the TranSw 120 could be connected to the receive antennas over a matching network. However the input impedances of the TranSw 120 vary significantly as transistors M₁-M₄ are switched on/off.

Thus matching networks that match the receive antennas with the varied impedances are not practical. In order overcome this issue, the input amplifiers are placed between the TranSw and the receive antennas to provide sufficient isolation between the inputs of the TranSw and the antennas. As a result, the matching networks are not affected by the varied input impedances of the TranSw. The output amplifier (OutAmp) drives the output current of the TranSw and adds more gain.

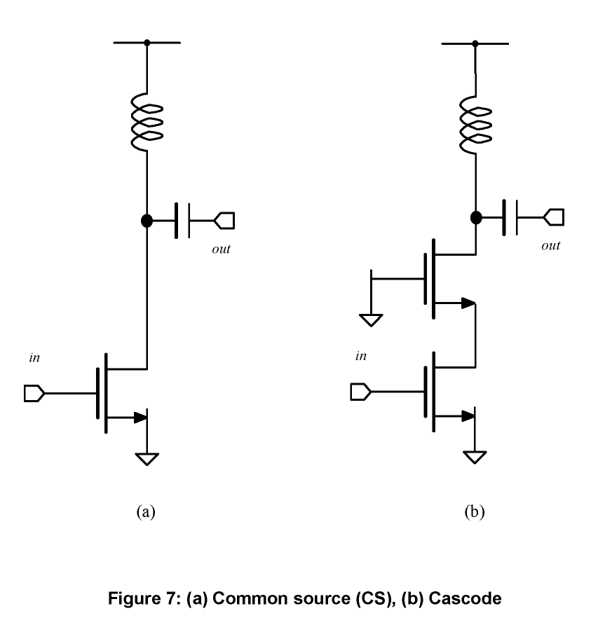

Amplifiers in low noise amplifiers suitable for a CMOS substrate are usually based on 3 common transconductance components: common gate (CG), common source (CS), and cascode amplifier. To achieve high gain, CS (FIG. 7a) and cascode (FIG. 7b) topologies are best suited for the transconductance components in the receiver circuit.

Although the cascode structure has the advantages of bandwidth improvement, input-output isolation, and high output impedance, it has more transistors, i.e. more noise sources than a CS transconductance component. Further, at 77 GHz, the gain provided by the CS transistor of the cascode structure is not high, as a result the noise contributed by the cascode transistor is significant. Accordingly, a CS topology is chosen as the transconductance component for the receiver circuit 100 of the embodiment.

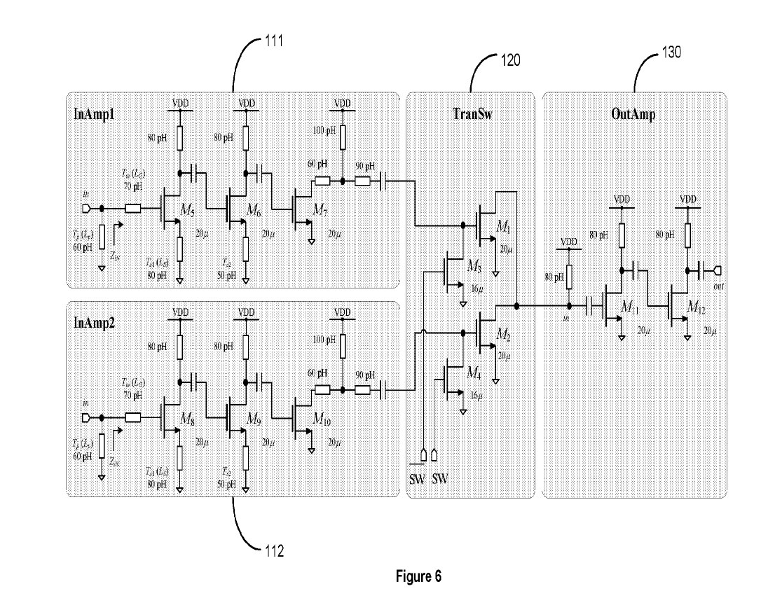

A simplified schematic of the proposed receiver circuit with switching for two antennas is shown in FIG. 6. The proposed receiver circuit consists of identical InAmp1 111 and InAmp2 112, TranSw 120, and OutAmp 130.

The input amplifiers 111,112 (InAmp1, InAmp2) each have three cascaded common source amplifiers with input matching. In the first stage of InAmp1 111 and InAmp2 112, the transistor (M₅/M₈) bias is set to optimal NFₘᵢₙ current density, which is 0.2 mA/μm. The optimal finger width to maximize fₘₐₓ is chosen and equal to 1 μm. The number of fingers is selected to match the optimal noise impedance, which is 20 fingers. Thus, the transistor's total width is 20 μm with minimum channel length of 65 nm. Degeneration and gate matching inductors L_{S} and L_{G} respectively are added to bring the input impedance of the CS transistor M₁ to match a 50 Ohm antenna. The input impedance can be expressed by

$${Z}_{IN} = {R}_{G} + {R}_{S} + {ω}_{T} {L}_{S} + j ( ω {L}_{S} + ω {L}_{G} - \frac{{ω}_{T}}{ω {g}_{m}} ) \qquad ( 3 )$$

where R_{G} and R_{S} are gate and source resistance respectively, ω_{T} is the maximum unity current gain frequency, and gₘ is the transconductance of M₅/M₈.

As expressed in (3), the values of L_{S} and L_{G} are chosen to cancel out the imaginary part of Zᵢₙ while making the real part of Zᵢₙ close to 50 Ohm. In this design L_{S} and L_{G} are 70 pH and 80 pH and implemented by micro strip transmission lines, Tₛ₁ and Tᵢₙ respectively. At 77 GHz the capacitive parasitics due to the input pad of the receiver circuit cannot be neglected, thus a shunt 60 pH Lₚ is added to cancel out this parasitic capacitance by a further micro strip transmission line Tₚ. Furthermore, Tₚ acts as electrostatic discharge (ESD) path to protect the gate of M₅/M₈. The output drain of the first stage is placed very close to the gate of the second stage in a circuit layout of an embodiment. As a result, the 80 pH output load, creates an LC resonance circuit, which maximizes the gain and avoids complex inter-stage matching network. This design is adopted in every stage of the InAmp1/InAmp2.

The second stage transistor M₆/M₉ (FIG. 6) has the same size and bias point as the transistor M₅/M₈ of the first stage. In the second stage, because the isolation of the CS topology is low, the input impedance of the second stage will affect the input impedance of the first stage. Therefore, a 50 pH degeneration inductor is adopted in this stage to obtain better input matching which is provided by micro strip transmission line Tₛ₂. The output load of this stage is an 80 pH inductor.

As shown in FIG. 6, the last stage M₇/M₁₀ has the same transistor size as well as bias point as the first two stages. All the matching/loading inductors used in the InAmp1/InAmp2 111,112 are micro strip transmission lines. The characteristic impedance of all transmission lines is 80 Ohm except Tₚ because Tₚ is also the ESD path for the input gate of the receiver circuit, its width is made wider to reduce resistance, its characteristic impedance is 50 Ohm.

Consisting of three cascade amplifier, InAmp1/InAmp2 111,112 provides sufficient isolation between receive antennas and the TranSw 120 thus the input matching are simplified and relaxed. Increasing the number of cascaded amplifiers would improve the isolation but would also decrease efficiency since the architecture would have greater power consumption and silicon area are traded due to the additional amplifiers. Reducing the number of cascaded amplifier makes the isolation lower thus making the input matching design more challenging.

As described above in relation to FIG. 4, the TranSw 120 consists of transistors M₁-M₄. The transistors' lengths are all 65 nm, the width of M₁ and M₂ are 20 μm, while the width of M₃ and M₄ are 16 μm.

The output amplifier 130 (OutAmp) drives the output of the TranSw consists of an inductive load (80 pH) made of micro strip transmission lines, and 2 cascaded identical common source amplifiers. The two transistors M₁₁ and M₁₂ have length and width of 65 nm and 20 μm. All the loads of the two amplifiers are 80 pH made of micro strip transmission lines. The output drain of the first stage is placed very close to the gate of the second stage in layout. So the 80 pH output load, creates a LC resonance circuit, which maximizes the gain and avoids complex inter-stage matching network.

### Simulation Results

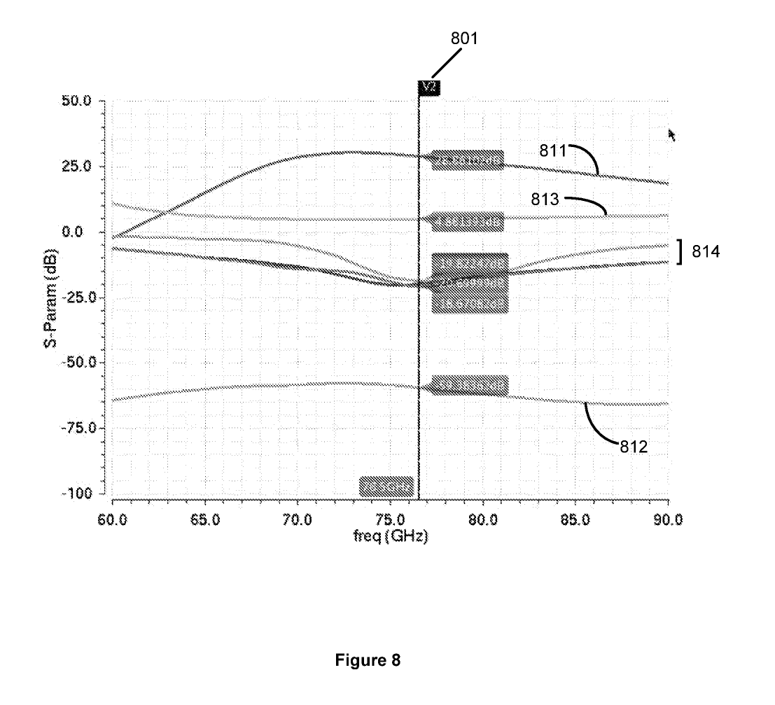

FIG. 8 shows the simulated S parameter of the selected channel 801 of the receiver circuit 100. At 76.5 GHz, the selected channel shows 28.8 dB of forward gain 811, −59 dB of reverse gain 812 and 4.8 dB of NF. The matching 814 at 2 input ports and output port are −20 dB, −18 dB and −19 dB respectively.

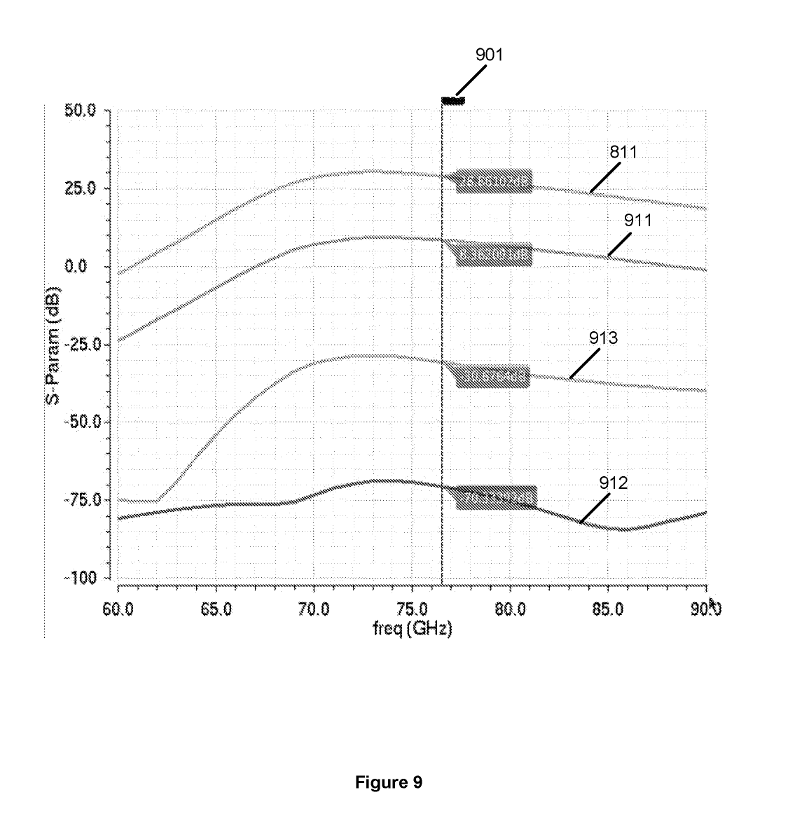

FIG. 9 shows the simulated S parameter of the blocked channel 901 of the receiver circuit 100. At 76.5 GHz, the blocked channel shows 8 dB of forward gain 911 (20 dB lower than forward gain 811 of the selected channel), −70 dB of reverse gain 812 and the leakage 913 from the input of selected channel to the input of blocked channel is −30 dB. The proposed receiver circuit, including bias circuit, consumes total 38.5 mA from 1.2 V supply.

It will be understood to persons skilled in the art of the invention that many modifications may be made without departing from the spirit and scope of the invention, in particular it will be apparent that certain features of embodiments of the invention can be employed to form further embodiments. For example, the embodiment is described as a receiver circuit comprising two or more antennas, however, the amplification and switching stages could be formed separately from the antennas as an amplification and switching circuit before being connected to the antennas.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A receiver circuit comprising:
a first antenna;
a second antenna;
an input amplification circuit comprising a first input amplifier circuit for amplifying a first signal received at the first antenna, and second input amplifier circuit for amplifying a second signal received at the second antenna;
a switching circuit comprising first and second transconductance components connected respectively to the first and second input amplifier circuits and to a common output, and a switching mechanism arranged to selectively turn on and off the first and second transconductance components so that only one of the first and second transconductance components is in an on state at any time, the first and second transconductance components further amplifying the first and second signals respectively when in an on state; and
an output amplification circuit connected to the common output of the switching circuit and comprising an output amplifier circuit for further amplifying the first and second signals when the first and second signals are outputted via the common output.

2. The receiver circuit as claimed in claim 1, wherein the first and second transconductance components comprise first and second transistors arranged in a common source topology.

3. The receiver circuit as claimed in claim 2, wherein the common output is formed by connecting the drains of the first and second transistors.

4. The receiver circuit as claimed in claim 1, further comprising a third antenna and wherein the input amplification circuit a third input amplifier circuit for amplifying a third signal received at the third antenna, and wherein the switching circuit comprises a third transconductance component connected to the third input amplifier circuit and the common output for further amplifying the third signal, and wherein the switching mechanism is further arranged to turn the third transconductance component on and off.

5. The receiver circuit as claimed in claim 3, wherein the third transconductance component comprise a third transistor arranged in a common source topology.

6. The receiver circuit as claimed in claim 2, wherein the switching mechanism comprises fourth and fifth transistors connected respectively to the first and second transistors and which when switched on respectively turn on the first and second transistors.

7. The receiver circuit as claimed in claim 5, wherein the switching mechanism comprises fourth, fifth and sixth transistors connected respectively to the first, second and third transistors and which when switched on respectively turn on the first, second and third transistors.

8. The receiver circuit as claimed in claim 1, wherein the first and second input amplifier circuits each comprise a plurality of common source amplifiers.

9. The receiver circuit as claimed in claim 8, wherein the first and second input amplifiers each comprise at least one input matching component.

10. The receiver circuit as claimed in claim 8, wherein the first and second input amplifier circuits each comprise three common source amplifiers.

11. The receiver circuit as claimed in claim 1, wherein the output amplifier circuit comprises a plurality of common source amplifiers.

12. The receiver circuit as claimed in claim 11, further comprising two common source amplifiers.

13. An amplifying and switching circuit for a radar receiver, the circuit comprising:
an input amplification circuit comprising a first input for connection to a first antenna, a second input for connection to a second antenna, a first input amplifier circuit for amplifying a first signal received at the first input, and second input amplifier circuit for amplifying a second signal received at the second input;
a switching circuit comprising first and second transconductance components connected respectively to the first and second input amplifier circuits and to a common output, and a switching mechanism arranged to selectively turn on and off the first and second transistors so that only one of the first and second transconductance components is in an on state at any time, the first and second transconductance components further amplifying the first and second signals respectively when in an on state; and
an output amplification circuit connected to the common output of the switching circuit and comprising an output amplifier circuit for further amplifying the first and second signals when the first and second signals are outputted via the common output.
